(19) United States
(12) Patent Application Publication
(10) Pub. No.: US 2006/0217991 A1
(43) Pub. Date: Sep. 28, 2006

(54) Method and apparatus for providing an information service

(75) Inventors: Robert L. Blake, Redhill (GB); Steffen Reymann, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE Philips Electronics N.V.

(21) Appl. No.: 10/555,019

(22) PCT Filed: Apr. 20, 2004
(86) PCT No.: PCT/IB04/01320

§ 371 Date: Oct. 31, 2005

(30) Foreign Application Priority Data
May 3, 2003 (GB) 0310274.6

(51) Int. Cl. G06Q 99/00

(52) U.S. Cl. 705/1; 705/5

(57) ABSTRACT

An information service such as an airport information system relies on a network of Bluetooth™ transceivers to transfer information to a user's mobile phone, which is equipped with basic calendar functionality. The transceivers are connected to (an information server, which downloads the calendar from each of the devices and writes or updates the reminder in each device as appropriate. The mobile phone calendar therefore provides a backup in the event that the user moves outside of the network coverage, while the server carries out all of the necessary processing, so that the system does not rely on complex calendar software within the mobile devices.

This invention relates to a method and apparatus for providing an information service to a portable device, particularly but not exclusively to an information service that relies on a distributed network of wireless transceivers to provide network coverage.

Information systems in locations such as airports currently rely on conventional screen display and audio technologies to provide information to customers. Typically, information such as flight times and gate numbers is displayed on screens mounted in prominent locations, supplemented by voice announcements when urgent information needs to be imparted.

As the use of mobile phones, personal digital assistants and other personal communication devices becomes increasingly widespread, the possibility of providing smart reminder services arises, where alerts are relayed to users' personal communication devices via a network of distributed transceivers. These alerts, for example warning the passenger to go to the departure gate, are displayed on the screen of the communication device and an audible warning may also be generated.

However, services such as these can only be provided reliably if complete coverage of the available area can be guaranteed. As soon as network black spots exist, users will fail to receive important notifications and updates, so leading to service failure.

It is desirable to offer a reliable service without the need to rely on complete network coverage. One way in which this can be achieved is by the use of a portable device with calendar functionality, which can store incoming information about future events and subsequently alert users at the appropriate time, even if the user is, at that time, outside network coverage.

One form of known portable device which combines communication and computing functionality is the Personal Digital Assistant (PDA). PDAs are available with basic calendar functionality that enables them to store reminders about upcoming events. U.S. Pat. No. 6,356,956 (Deo et al.) discloses a system for transmitting reminder information from a host computer to a PDA via a wireless link. The reminder is stored in the PDA's calendar and recalled at the appropriate time.

A remotely updatable PDA is disclosed in U.S. Pat. No. 6,163,274 (Lindgren). The PDA receives new calendar data and/or updates broadcast from a base computer station via a paging system. Software stored in and executable by the PDA recognises the incoming calendar data and stores the updated and new data. The PDA software can also recognise any scheduling conflict and, in addition to alerting the user to such conflict, causes the PDA to transmit a query concerning the conflict to the pager service.

However, the known systems are directed to PDAs with advanced calendar software which can recognise and resolve conflicts. In a situation such as the airport information system described above, a reliable information service can only be provided if all types of portable device are catered for, from mobile phones with only the most basic calendar functionality, through to the most sophisticated PDAs, without the need to provide custom software to each device to enable it to function.

The present invention seeks to provide a solution to the above problem.

According to a first aspect of the present invention there is provided a method of providing an information service from an information server to a portable device, wherein the portable device is operative to store time dependent information provided by the server, the method comprising the steps of requesting data relating to the information stored at the portable device, determining the current status of the stored information from the requested data and transmitting new or updated information from the server to the portable device in accordance with the determined status.

Rather than relying on the portable device to carry out the necessary checking of updated information, the server requests the relevant information from the portable device and carries out the necessary processing. The functionality provided by the portable device can therefore be much simpler than if it were required to carry out the processing.

The server's request for information can involve retrieving the calendar from the portable device and determining the current status of the information from the calendar. As a consequence, the system can therefore deal with portable devices with only basic calendar functionality, the main requirement being that information in the calendar is accessible to the server.

The determination of the status of the information can involve the server determining if a reminder is stored in relation to a particular action that is scheduled to occur at a specified time. If no such reminder is stored, the method may comprise writing a reminder to the portable device.

The determination of the status can also comprise determining if the reminder arranged to be provided by the device is up-to-date. If it is not, the method may comprise updating the reminder on the device.

Advantageously, where an up-to-date reminder already exists, there is no need for the server to retransmit the information to the device.

Where an alert is provided by the server and the mobile device receives the alert, the alert can be notified to the user in preference to notifying the user of a reminder stored at the device. However, in the event that the device does not receive the alert, the stored reminder can be notified to the user, so effectively completing the network coverage.

According to the invention, there is further provided an information server for providing an information service to a portable device, wherein the portable device is operative to store time dependent information provided by the server, the server being configured to request data associated with the information stored at the portable device, to determine the current status of the stored information from the requested data and to transmit new or updated information to the portable device in accordance with the determined status.

The information server can further comprise at least one transceiver connected to the server for communicating with the portable device.

According to the invention, there is still further provided a portable device for receiving an information service from an information server, the device comprising means for storing time related information provided by the server, means operative to provide data associated with the time related information stored at the device in response to a request from the server and means for overwriting stored information in response to updated information received from the server.

Embodiments of the present invention will now be described by way of example with reference to the accompanying drawings in which:

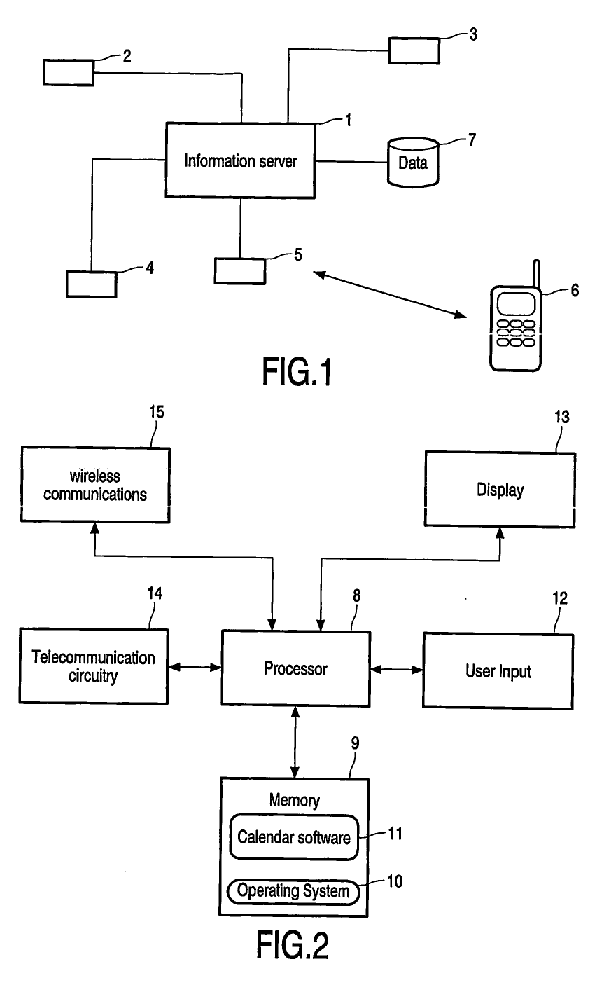

FIG. 1 is a schematic illustration of an airport information system in which an information server communicates with a users mobile phone via a plurality of wireless transceiver devices;

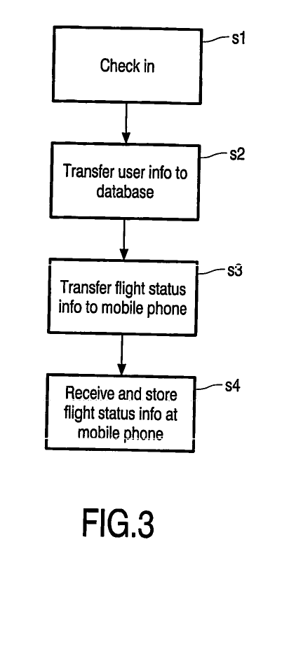

FIG. 2 is a schematic diagram illustrating the functionality of a Bluetooth™ enabled mobile phone;

FIG. 3 is a flow diagram illustrating the initial storage of flight status information into a mobile phone calendar at an airport check-in point;

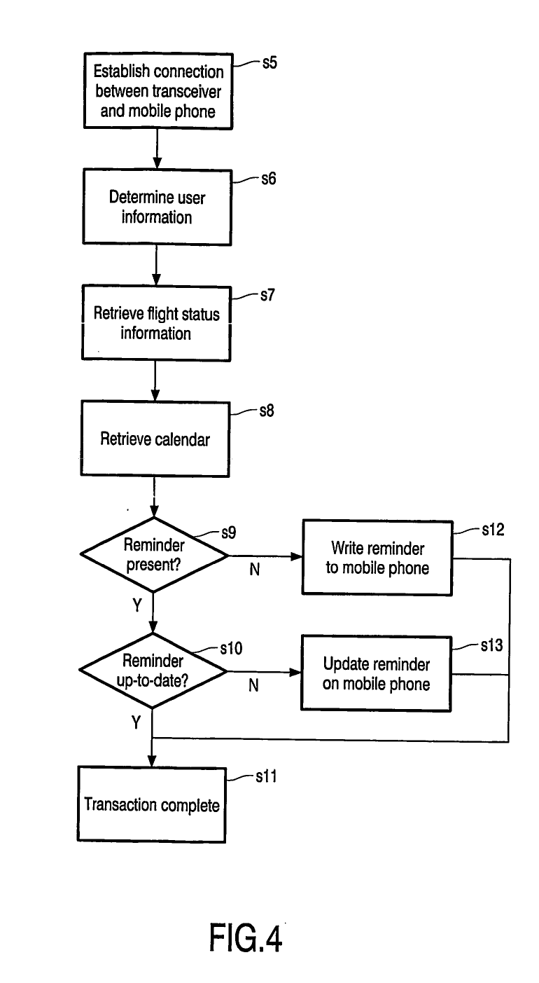

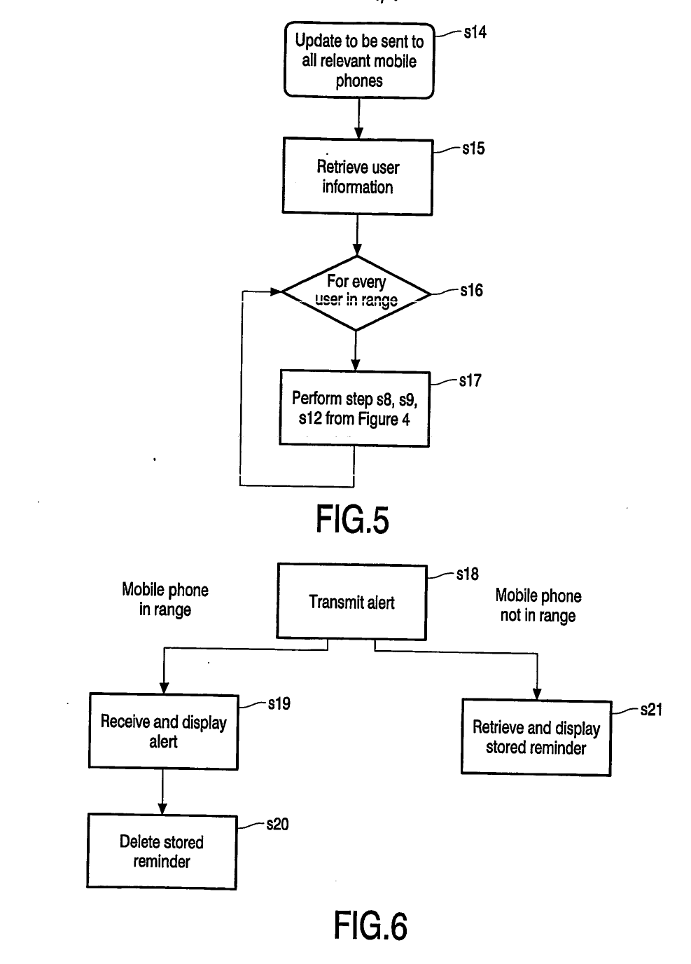

FIG. 4 is a flow diagram illustrating a method of updating time-critical information on the mobile phone shown in FIG. 2 when the mobile phone comes within transceiver range;

FIG. 5 is a flow diagram illustrating the transmission of a flight status update to all relevant mobile phones; and

FIG. 6 is a flow diagram illustrating the effect of transmission of an alert from the information server of FIG. 1 for the situations where the mobile phone is either in range or not in range.

FIG. 1 shows an example of an information broadcast system according to the invention operative in, for example, an airport environment. A central information server 1 is connected to a plurality of fixed transceiver devices 2-5 by conventional cabling. These transceiver devices 2-5 operate according to a wireless protocol, for example the Bluetooth™ protocol, to communicate with individual mobile devices, for example, mobile phones 6 held by passengers. The information server 1 is also connected to a flight passenger database 7, which contains information about passengers currently checked in as well as the status of flights due, including, for example, departure gate information together with delay and cancellation information.

FIG. 2 is a schematic illustration of the functionality of a mobile phone 6 according to the invention. The mobile phone 6 comprises a central processor 8 and a memory 9, which includes the mobile phone operating system software 10. The memory 9 also includes calendar application software 11, which permits the storage of time critical alert data and its notification to the user at the relevant time. The mobile phone 6 also includes a user input device such as a keypad 12, a display/audio output 13, telecommunication circuitry 14 for carrying out standard telephone communication functionality and a wireless communications module 15. The wireless communications module 15 is, for example, a Bluetooth™ communication module that enables the mobile phone 6 to communicate with other Bluetooth™ enabled devices.

Referring to FIG. 3, when a user checks in for his or her flight (step s1), the users mobile phone access details, for example the mobile phone's Bluetooth™ address, are transferred to the database 7 via a transceiver 2 at the check-in point (step s2). The currently available status information for the flight is then transferred to the user's mobile phone 6 using the Bluetooth™ protocol, via the transceiver 2 (step s3). The mobile phone 6 therefore receives the time at which the flight is scheduled to depart and the time at which the user should go to the appropriate gate and stores this information into the mobile phone's calendar 11 (step s4). Subsequently, as the user wanders around the airport waiting for the flight to depart, the information broadcast system operates as will now be described in detail.

As mentioned above, an airport or other environment in which the system is implemented is served by a plurality of Bluetooth™ transceivers 2-5, since the coverage area, namely the range of operation of a single transceiver, is limited in accordance with the Bluetooth™ protocol. As the user wanders around the airport, he or she will move from the coverage area of one transceiver to that of another. A single transceiver system is possible where the operating protocol permits this.

Referring to FIG. 4, when a passenger's mobile phone 6 enters or re-enters a transceiver's 5 coverage area, it establishes a connection to the transceiver 5 and hence to the information server 1 in accordance with the standard Bluetooth™ protocol (step s5). The information server 1 determines the identity of the passenger by comparing the passenger information, for example the mobile phone's Bluetooth™ address, to that stored in the passenger database 7 (step s6) and retrieves the relevant current flight status information for that passenger (step s7). The information server 1 then retrieves the calendar from the mobile phone 6 (step s8) and determines if a reminder relating to the flight information is present (step s9). If a reminder is present, then the information server 1 determines if the reminder is up-to-date y comparing the flight status information retrieved from the passenger database 7 with the mobile phone flight status information (step s10). This comparison is, for example, based on a comparison of timestamp information, which is updated every time a flight status update is issued and stored with the flight status information. Alternatively, the comparison is based on comparing the time at which the user is to be alerted according to the mobile phone calendar in relation to the current alert time for the latest available reminder according to the passenger database 7. If the reminder stored at the mobile phone 6 is up-to-date, then the current interaction between the information server 1 and the mobile phone 6 is complete and no further action is required (step s11).

However, if the information server 1 determines that no reminder is present at step s9, then it transfers the current flight status information to the mobile phone 6, which stores this information in its calendar (step s12).

Similarly, if the information server 1 determines that the reminder, although present, is out-of-date, at step s10, it sends up-to-date information to the mobile phone 6, which is stored in its calendar (step s13).

Referring to FIG. 5, where the information server 1 receives notification of an update to the flight details (step s14), for example information that the flight has been delayed, it retrieves a list of the Bluetooth™ addresses of all the checked in passengers for that flight (step s15), which therefore comprises all the passengers for whom this information is relevant. For each passenger (step s16), it then retrieves the calendar (step s8 from FIG. 4) and determines whether a reminder is present (step s9 from FIG. 4). In the case of a new update, a reminder will not be present, so the information server 1 writes the reminder to the mobile phone 6 (step s12 from FIG. 4) and moves on to the next user (step s16). This information is received and stored by each passenger's mobile phone 6 in its calendar.

In the event that a mobile phone 6 is outside the range of any of the transceivers 2-5, the information server 1 cannot establish a connection and so moves on to the next user (step s16). The calendar in an out-of-range mobile phone 6 is obviously not updated. It therefore retains the previous information and will remind its owner of the previously stored flight details at the appropriate time. For example, in the event that the calendar of a mobile phone 6 is set to remind a passenger that he must go to the departure gate at 9 pm, and he misses a subsequent update to go to the departure gate at 10 pm, because he is out of transceiver range, then at 9 pm, the mobile phone calendar 11 will flash up an alert on the mobile phone display 13 to warn the passenger to proceed to the departure gate. The mobile phone 6 therefore operates as a backup for the network of transceivers 2-5, ensuring that the passenger has some warning of time critical events.

When the passenger subsequently comes within range of one of the transceivers 2-5, the procedure described above with reference to FIG. 4 will again operate. The information server 1 will in this case determine that the 9 pm update stored on the passenger's mobile phone 6 is out of date (step s10) and will transmit the up-to-date information for the passenger to go to the gate at 10 pm, which will be stored in the mobile phone calendar 11 in place of the previous reminder (step s13).

Referring to FIG. 6, when the reminder time arrives, the information server 1 sends out a further alert broadcast to all of the required passengers (step s18). In the event that a mobile phone 6 is within range of a transceiver 2-5, the alert is transferred to and displayed on the mobile phone display 13 (step s19). The stored reminder may then be deleted (step s20). If the mobile phone 6 is out of range of a transceiver, then as described above, the mobile phone calendar 11 will provide the alert (step s21). In either of these cases, both the information server 1 and the mobile phone calendar 11 provide, at 10 pm, the information that the passenger should go to the departure gate. The mobile phone 6 is again acting as a backup for the transceiver network 2-5, to fill any gaps in network coverage.

From reading the present disclosure, other variations and modifications will be apparent to persons skilled in the art. For example, wireless communication systems other than Bluetooth™ can be used, including wireless Local Area Network products based on the IEEE 802.11b specification, commonly known as the Wi-Fi protocol. It will also be clearly understood that while the invention has been described primarily in relation to an airport information system, its use is not restricted to this particular environment and it can be used in any situation where a network of transceivers would be effective to transfer information to mobile phones. It is nevertheless ideally suited for use in enclosed or crowded environments such as airports, exhibitions and theme parks. Furthermore, while the specification uses a mobile phone as the primary example of the invention, any portable device which has similar functionality could be used, including but not limited to personal digital assistants and handheld/laptop computers.

Although claims have been formulated in this application to particular combinations of features, it should be understood that the scope of disclosure of the present invention also includes any number of features or any other combinations of features disclosed herein either implicitly or explicitly or any generalisation thereof, whether or not it relates to the same invention as presently claimed in any claim or whether or not it mitigates any or all of the scientific problems as does the present invention. The applicants hereby give notice that new claims may be formulated to such features and/or combination of features during the prosecution of the present application or any further application derived therefrom.

1. A method of providing an information service from an information server (1) to a portable device (6), wherein the portable device (6) is operative to store time dependent information provided by the server (1), the method comprising the steps of:
requesting data relating to the information stored at the portable device (6):
determining the current status of the stored information from the requested data; and
transmitting new or updated information from the server (1) to the portable device (6) in accordance with the determined status.

2. A method according to claim 1, wherein the step of requesting data relating to the stored information comprises reading calendar information from the portable device (6).

3. A method according to claim 1, wherein the information service is provided over a predetermined area, further comprising the step of determining user information associated with the device (6) when the device enters the predetermined area.

4. A method according to claim 1, wherein the time dependent information comprises information relating to an action that is scheduled to occur at a specified time.

5. A method according to claim 4, wherein the step of determining the status of the information comprises determining if the device is arranged to provide a reminder relating to the action.

6. A method according to claim 5, further comprising, in the event that the device is not arranged to provide the reminder, writing a reminder to the device (6).

7. A method according to claim 5, further comprising, in the event that the device is arranged to provide the reminder, determining if the reminder is up-to-date.

8. A method according to claim 7, further comprising, in the event that the reminder is not up-to-date, updating the reminder on the device (6).

9. A method according to claim 7, comprising determining if the reminder is up-to-date by comparing timestamp information associated with the stored reminder with timestamp information associated with a latest available reminder.

10. A method according to claim 7, comprising determining if the reminder is up-to-date by comparing the time at which the stored reminder is set to remind the user of the action with the time at which a latest available reminder would be set to remind the user of the action.

11. A method according to claim 4, further comprising providing an alert to the device (6) in relation to the action, receiving the alert at the device and notifying the alert to the user in preference to notifying the user of a reminder stored at the device.

12. A method according to claim 11, further comprising deleting the stored reminder on receipt of the alert.

13. A method according to claim 11, comprising, in the event that the device does not receive the alert, notifying the stored reminder to the user.

14. An information server (1) for providing an information service to a portable device (6), wherein the portable device (6) is operative to store time dependent information provided by the server (1), the server (1) being configured to:
request data associated with the information stored at the portable device (6):
determine the current status of the stored information from the requested data; and
transmit new or updated information to the portable device (6) in accordance with the determined status.

15. An information server (1) according to claim 14, further comprising at least one transceiver (2-5) connected to the server (1) for communicating with the portable device (6).

16. An information server according to claim 14, wherein the server (1) is arranged to retrieve calendar information stored on said device for the purpose of determining the current status of the information.

17. A server according to claim 14, operable to connect to a database (8) that includes user information.

18. A portable device (6) for receiving an information service from an information server (1), the device (6) comprising:
means for storing time related information provided by the server (1);
means operative to provide data associated with the time related information stored at the device (6) in response to a request from the information server; and
means for overwriting stored information in response to updated information received from the server (1).

19. A portable device (6) according to claim 18, wherein the data associated with the time related information comprises calendar information stored at the device.
